(19) United States
(12) Patent Application Publication
(10) Pub. No.: US 2026/0288942 A1
(43) Pub. Date: Sep. 24, 2026

(54) SYSTEM FOR SCALING AND TRANSFORMING HIGH VOLUME ENTITYCENTRIC DATA SETS INTO DEVICE-CENTRIC BEHAVIOR CYCLES

(71) Applicant: CrowdStrike, Inc., Sunnyvale, CA (US)

(72) Inventors: Owen McCusker, East Lyme, CT (US); Mitchell Wyle, Bellevue, WA (US); Dav Clark, Towson, MD (US)

(21) Appl. No.: 19/084,368

(22) Filed: Mar. 19, 2025

(51) Int. Cl. G06F 21/55

(52) U.S. Cl. CPC G06F 21/554

(57) ABSTRACT

The present disclosure provides an approach of rendering sensor data into a time series, wherein the sensor data includes one or more features associated with an entity across one or more time windows. The approach compresses the time series across the one or more time windows to a timeframe that is less than the one or more time windows. The approach determines a baseline environment of the one or more features of the sensor data, wherein the baseline environment includes expected performance metrics of the one or more features across the one or more time windows. The approach then detects an anomalous event associated with the one or more features of the sensor data within the time series, wherein the anomalous event includes unexpected performance metrics of the one or more features within the timeframe that deviates from the expected performance of the baseline environment.

### TECHNICAL FIELD

Aspects of the present disclosure relate to cybersecurity, and more particularly, to detecting anomalous events within device-centric behavior cycles based on high volume entity-centric data sets.

### BACKGROUND

Cybersecurity refers to the practice of protecting computer systems, networks, and digital assets from theft, damage, unauthorized access, and various forms of cyber threats. Cybersecurity threats encompass a wide range of activities and actions that pose risks to the confidentiality, integrity, and availability of computer systems and data. These threats can include malicious activities such as viruses, ransomware, and hacking attempts aimed at exploiting vulnerabilities in software or hardware. Additionally, cybersecurity threats also encompass suspicious activities, such as unusual patterns of network traffic or unauthorized access attempts, which may indicate potential security breaches or weaknesses that need investigation and mitigation.

Artificial intelligence (AI) is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing the mathematical and computational frameworks used to extract patterns and insights from data. Large language models, a specialized category within machine learning models, are trained on vast amounts of text data to capture the nuances of language and context. By combining advanced machine learning techniques with enormous datasets, large language models harness data-driven approaches to achieve highly sophisticated language understanding and generation capabilities. AI models, include machine learning models, large language models, and other types of models that are based on neural networks, genetic algorithms, expert systems, Bayesian networks, reinforcement learning, decision trees, or combination thereof.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1A is a block diagram that illustrates an example system for detecting anomalous events within device-centric behavior cycles based on high volume entity-centric data sets, in accordance with some embodiments of the present disclosure.

FIG. 1B is a block diagram that illustrates an example behavior cycle processing, in accordance with some embodiments of the present disclosure.

FIG. 1C is a diagram that illustrates an example of an anomalous event, in accordance with some embodiments of the present disclosure.

FIG. 2 is a diagram that illustrates an example of a method for detecting anomalous events within device-centric behavior cycles based on high volume entity-centric data sets, in accordance with some embodiments of the present disclosure.

FIG. 3 is a diagram that illustrates an example of a behavior cycle, in accordance with some embodiments of the present disclosure.

FIG. 4 is a flow diagram of a method for detecting anomalous events within device-centric behavior cycles based on high volume entity-centric data sets, in accordance with some embodiments of the present disclosure.

FIG. 5 is a block diagram that illustrates an example system for detecting anomalous events within device-centric behavior cycles based on high volume entity-centric data sets, in accordance with some embodiments of the present disclosure.

FIG. 6 is a block diagram of an example computing device that may perform one or more of the operations described herein, in accordance with some embodiments of the present disclosure.

### DETAILED DESCRIPTION

Lateral movement in cybersecurity refers to techniques used by threat actors (TAs) to navigate through a network, escalating privileges and accessing sensitive systems by exploiting valid credentials and vulnerabilities. Lateral movement often involves blending malicious activities with normal network operations, requiring advanced monitoring to identify anomalies.

Detecting lateral movements in computer networks is challenging for several reasons. Threat actors often use legitimate credentials to move laterally, making their activities appear normal and authorized. This makes it difficult to distinguish between malicious and regular user behavior. Moreover, enterprise networks are large and complex, with numerous users, devices, and permissions. This complexity creates a vast amount of data, making it challenging to identify abnormal patterns indicative of lateral movement. Likewise, networks are dynamic, with constant changes in user roles, permissions, and access patterns. This variability can mask malicious activities as normal, especially when organizations do not regularly update their security baselines.

A challenge found in enhancing lateral movement detection through machine learning is the vast amount of data, which utilizes high amounts of resources to process the vast amount of data due to multiple devices present within the system. Conventional detection methods often rely on anomaly detection, which can produce high false-positive rates due to the lack of labeled data.

The present disclosure addresses the challenge of detecting anomalous events within computer networks by providing an ability to dynamically match timescale to threat detection. By adjusting a behavioral point of view, to create behavior cycles to measure device-centric behavior changes. Device-centric behavior changes may allow for measurement of changes and rates of changes of behaviors at an entity variance per device within the system. The rates of changes may provide value and make sense of false positives, when training new models and analyzing existing detection models. A device-centric entity prevalence variance may be established and may be utilized to build out a multi-modal visualization of cycles (e.g., sonification) of anomalous events.

The present disclosure allows for the use of behavior cycles by transforming data to a reduced or compress set scaled by size and by time. The scaled data may be utilized to develop data pipelines that are built based on behavior cycles. The scaled data is device-centric and location-centric which allows for the logical compression of behaviors over time and place. The present disclosure leverages entity-centric data sets, such as being drive by sensors on endpoints, and offers the flexibility to promote the creation of network sensors to augment an understanding of behavior inside and outside of a network. These data pipelines may be established to protect not only a single network, but also enterprise networks engaged in supply chains.

In one embodiment, the present disclosure uses a processing device to render sensor data into a time series, where the sensor data includes one or more features associated with an entity in a computer network across one or more time windows. In one embodiment, the time series comprises a multivariate time series that tracks multiple variables associated with the one or more features.

The processing device compresses the time series across the one or more time windows to a timeframe that is less that the one or more time windows. A timeframe associated with the one or more time windows may be set arbitrarily being driven by performance metrics from the environment. In one embodiment, the one or more time windows may comprise twenty-four hour period and the timeframe comprises a one hour period such that the information of the time series is compressed into the timeframe of the one hour period. In another embodiment, the one or more time windows may comprise a plurality of months and the timeframe comprises a day, week, or month such that the information of the time series is compressed into the timeframe of the day, week, or month period.

The processing device determines a baseline environment of the one or more features of the sensor data, wherein the baseline environment includes expected performance metrics of the one or more features across the one or more time windows. In one embodiment, the expected performance metrics of the baseline environment include information of expected results of the one or more features within the one or more time windows. In some embodiments, the expected performance metrics of the one or more features may be the same or different for each of the one or more time windows. In some embodiments, the expected performance metrics of the one or more features may differ for different time windows at different time periods. For example, the expected performance metrics may differ based on seasonal changes, different time periods within a day, or the like. In some embodiments, device baselines may be created over time by behavior cycle tuples, which may be utilized to expose threat archetypes based on the baselines differentiating different classes of device (e.g., Internet of Things (IoT) devices) through their cyclic behaviors.

In one embodiment, the processing device detects an anomalous event associated with the one or more features of the sensor data within the time series. The anomalous event includes unexpected performance metrics of the one or more features within the timeframe that deviate from the expected performance metrics of the baseline environment. In some embodiments, the unexpected performance metrics of the one or more features may be the same or different for each of the one or more time windows. In some embodiments, the unexpected performance metrics of the one or more features may differ for different time windows at different time periods. For example, the unexpected performance metrics may differ based on seasonal changes, different time periods within a day, or the like.

The processing device detects a rate of change of the anomalous event associated with the one or more features of the time series within at least the timeframe. In some embodiments, the rate of change of the anomalous event is detected within the one or more time windows. For example, a derivative or rate of change of behavior over time may assist in the detection of the anomalous event over different time periods that are greater than the timeframe. In detecting lateral movement within a device, the rate of change in the average command line length within a timeframe may signal an anomalous event within the timeframe.

As discussed herein, the present disclosure provides an approach of detecting anomalous events associated with one or more feature of sensor data within a time series, where the time series is compress across one or more time windows to a timeframe that is less than the one or more time windows. In addition, the present disclosure provides an improvement to the technological field of cybersecurity by transforming the entity-centric data into the device-centric behavior cycles, allowing for more accurate and reliable detection of malicious threats based on detection of the anomalous events. The present disclosure provides an approach that provides a multi-modal visualization incorporating the use of sound that leverages behavior cycles to exposing more signal from noise over longer periods of time.

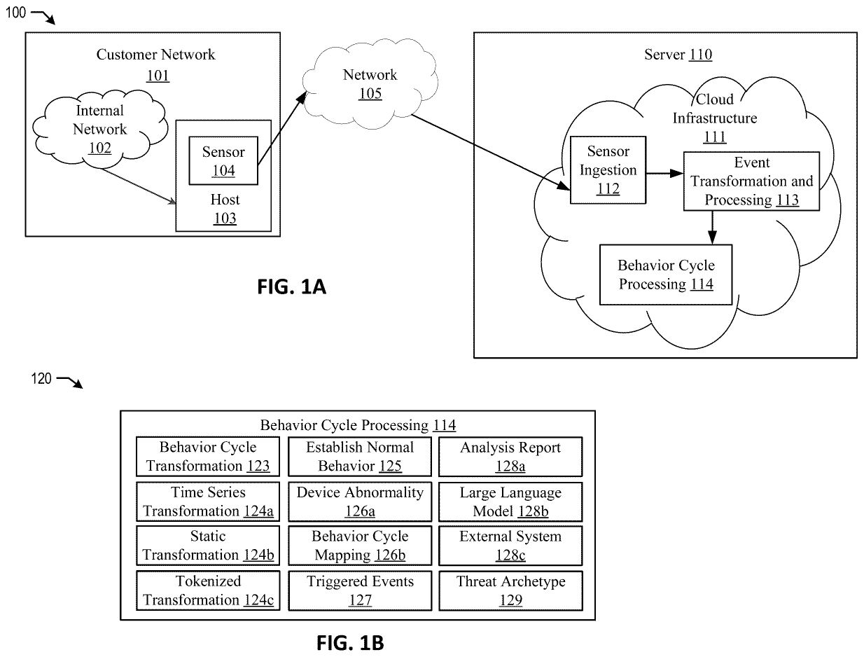

FIG. 1A is a block diagram that illustrates an example system 100 for detecting anomalous events within device-centric behavior cycles based on high volume entity-centric data sets, in accordance with some embodiments of the present disclosure.

System 100 includes a customer network 101, a server 110, and a network 105. The customer network 101 may include an internal network 102 and a host 103, where the host 103 includes a sensor 104. The sensor 104 may collect information related to the host 103 within the customer network 101. The system 100 of FIG. 1A shows a customer network 101, but the customer network 101 may comprise any type of network (e.g., residential, private, business, enterprise, etc.) and the disclosure is not intended to be limited to the examples disclosed herein.

The sensor 104 may provide collected data to the server 110. The sensor 104 may provide the data to the server 110 via network 105. The network 105 may be a wired or wireless network. The server 110 receives the data from the sensor 104 at a sensor ingestion 112 within a cloud infrastructure 111 within the server 110. The cloud infrastructure 111 includes the sensor ingestion, an event transformation and processing 113, and a behavior cycle processing 114. The sensor ingestion 112 may obtain the data from the sensor 104 and perform some initial processing of the data. For example, the sensor ingestion 112 may process the data from the sensor 104 and render the sensor data into a time series.

The event transformation and processing 113 may obtain the time series from the sensor ingestion 112 and compress the data within the time series. In some embodiments, the data within the time series may be collected within an extended time period, which includes vast amount of data. The compression may allow for the data to be compressed to a reduced time period that is less than the extended time period in which the data was collected. For example, the data may be collected over a year and the data may be compress down to a month or week time frame to allow for review of all the data within the month or week compressed time frame. The behavior of the host within the compressed data can be examined to determine whether any unexpected behaviors occur during the month or week compressed time frame. The data may be collected within any extended time frame and compressed to any reduced time frame, such that the disclosure is not intended to be limited to the examples disclosed herein. In some embodiments, the event transformation and processing 113 may perform a time series transformation of the data within the time series. In some embodiments, the event transformation and processing 113 may perform a static transformation of the data within the time series.

The behavior cycle processing 114 may obtain the compressed data from the event transformation and processing 113. The behavior cycle processing 114 may determine whether any anomalous events associated with the sensor data are within the time series. The behavior cycle processing 114 examines the behavior cycles within the time series to determine whether any anomalous events associated with the sensor data are within the time series. In some embodiments, behavior cycles may be akin to health measurements. For example, an entity is akin to a single heartbeat derived from a sensor, which may allow a model to look for anomalies in the structure of the single heartbeat (e.g., command line tokens). A device-centric behavior cycle is akin to a measurement of heartbeats per second (e.g., average command line size, entropy over time).

Behavior cycles may also be akin to cycles within sound. Sound may have a beat and a cycle, where each cycle is akin to a device behavior time/location period (e.g., hour, day, month, or year). A sound “beat” may be broken down into a set of frequency bins (e.g., spectrograph), where each bin is a behavior cycle feature from a device. Feature sets may be combined into categories (e.g., file, process, network). Behavior cycles may have a set periodicity with a time window (e.g., hour, day, month, year, etc.). Behavior cycles may be comprised of behavior cycle categories, where categories may be general files or specific file types (e.g., processes, services, or networks). Behavior cycle categories may be comprised of behavior cycle category features, where the features are measurements per unit time (e.g., average command line length per hour, entropy, variance, etc.). Each behavior cycle may comprise a time period and a feature set. In some embodiments, behavior cycles may be defined within a specific time-window. A set of cycle features may be within a cycle, where each cycle feature is a representation of device behavior over time.

In some embodiments, behavior cycles may include transformations derived from other cycles. For example, twenty-four hour cycles of behaviors may be summarized in a day behavior cycle. Statistical analysis may be utilized to find average behaviors, with a variance associated with the behaviors. In another example, multiple days may be summarized in a month behavior cycle, and in yet another example, multiple months may be summarized in a year behavior cycle. In some embodiments, behavior cycle data may be accumulated. Behavior cycle data sets may have high dimensionality. For example, a one-hour/day/n behavior cycle can have a number of categories (e.g., file, process, etc.). Each behavior cycle category may contain a number of transformed features (e.g., file attribute entropy). Behavior cycle models can be tuned to specific behavior cycle categories and/or behavior cycle category features within the sample space. In some embodiments, multiple and/or concurrent behavior cycle based models may be utilized to find/expose long term patterns in device-centric data. Behavior cycles can be rolled up by system/device archetypes. In some embodiments, behavior cycles of specific operating systems may be accumulated to understand changes in behaviors of an operating system based on version and patch level. In some embodiments, behavior cycles can be rolled up over a physical or virtual locations or networks, such that data may be compressed over longer periods of times. In some embodiments, behavior cycles may be able to be rolled up to contain an overall supply chain. Looking for changes within an overall supply chain may allow for finding higher grain trends within industries and countries critical infrastructure.

In some embodiments, an indication of the anomalous event may be provided. For example, the behavior cycle processing 114, upon detection of an anomalous event, may transmit an indication of the detection of the anomalous event within the time series. The behavior cycle processing 114 may cause the indication of the detection of the anomalous event to be stored on the cloud infrastructure 111 or the server 110. In some embodiments, the behavior cycle processing 114 may present the indication of the detection of the anomalous event on a display device. For example, with reference to diagram 130 of FIG. 1C, the indication of the detection of the anomalous event 131 may be displayed as the multi-modal visualization of cycles (e.g., sonification). The multi-modal visualization of cycles (e.g., sonification) including the indication of the detection of the anomalous event may allow for a visual representation of one or more anomalous events within the time series.

At least one advantage of the disclosure is that the disclosure leverages behavior cycles transformations within data processing pipelines. At least another advantage of the disclosure is that the disclosure allows the fusion of events originating from a device, a customer site, and a grouping of customers working together within a supply chain. At least another advantage of the disclosure is that the disclosure leverages behavior cycle datasets for machine learning and creates different types complimentary of machine learning models. Each model may be tuned to a specific set of behavior cycle categories and features. Behavior cycles establish the possibility of creating user interface capabilities that leverage both visualization and sound.

FIG. 1B is a diagram 120 that illustrates an example of behavior cycle processing procedures. Behavior cycle processing 114 may include multiple procedures in the processing of behavior cycles. For example, some procedures include a behavior cycle transformation 123, time series transformation 124a, a static transformation 124b, a tokenized transformation 124c, establish normal behavior 125, device abnormality 126a, behavior cycle mapping 126b, triggered events 127, analysis report 128a, large language model 128b, external system 128c, or threat archetype 129.

The behavior cycle transformation 123 may perform device-centric behavior cycle transformations based on a time window. The time series transformation 124a may perform time series transformations on behavior cycles. The static transformation 124b may perform static transformations on behavior cycles. The tokenized transformation 124c may perform tokenized transformations on behavior cycle data to be inputted into as input for large language model using mappings. For example, the tokenized transformation 124c may generate a vector of the behavior cycle data in preparation for inputting the vector into the large language model. In some embodiments, behavior cycles may be converted or generated into a vector (e.g., tokenized) through the use of an ontology. The vectors (e.g., tokens) may then be inputted into a large language model, which may allow for the large language model to be queried. For example, the large language model may be searched to request information related to anomalous command line behavior for an entity. The query is allowed to be conducted due in part to the vector being inputted into the large language model. The vector allowing for the large language model to be queried allows for natural language processing (NLP) reasoning of raw behavior cycles fused with data sets that may be populated within the large language model. The behavior cycle data may be compressed and provide a perspective of device behaviors such that the vector can be tuned or scaled based on a context window (e.g., input constraints) of the large language model.

The establish normal behavior 125 may establish normal behaviors for device or device grouping from time windows. The device abnormality 126a may detect device abnormalities in behaviors over multiple time windows. The behavior cycle mapping 126b may map behavior cycle groupings into known attacks. The triggered events 127 may send events triggered to an external system. The analysis report 128a may generate at least one of triage anomaly events, an analysis report, or fuse raw data for analysis. The large language model 128b may send tokenized events triggered to the large language model. The external system 128c may send events triggered to external systems. The threat archetype 129 may associate behavior anomalies to threat archetypes.

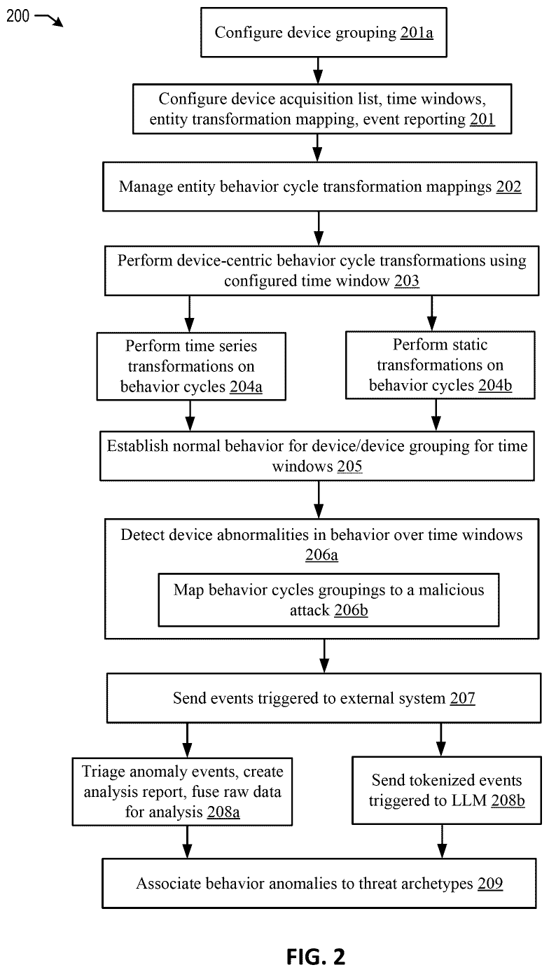

FIG. 2 is a flow diagram 200 that illustrates an example of a method for detecting anomalous events, in accordance with some embodiments.

With reference to FIG. 2, the flow diagram may begin at block 201a, where device groupings are configured. At block 201, a device acquisition list, time windows, entity transformation mappings, or event reporting may be configured. At block 202, entity behavior cycle transformation mappings may be managed. At block 203, device-centric behavior cycle transformations using a configured time window may be performed. In some embodiments, at block 204a, time series transformations on behavior cycles may be performed. In some embodiments, at block 204b, static transformations on behavior cycles may be performed. At block 205, normal behavior for device or device grouping for the time window may be established. At block 206a, device abnormalities in the behavior cycles over the time window may be detected. In some embodiments, at block 206b, behavior cycle groupings may be mapped to a malicious attack. At block 207, events triggered may be sent to an external system. In some embodiments, at block 208a, a triage of anomaly events, create analysis report, or fuse raw data for analysis may be performed. In some embodiments, at block 208b, tokenized events triggered may be sent to a large language model. At block 209, behavior anomalies may be associated to threat archetypes.

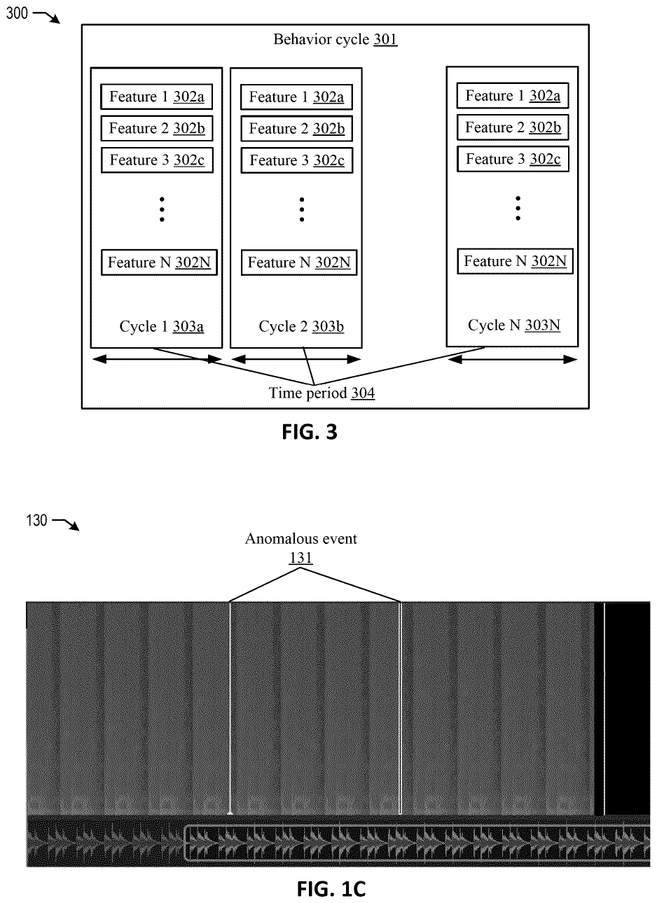

FIG. 3 is a diagram 300 of a behavior cycle 301 for detecting anomalous events within device-centric behavior cycles, in accordance with some embodiments.

The behavior cycle 301 may include one or more transformed features related to sensor data. For example, in the example diagram 300 of FIG. 3, the behavior cycle 301 includes feature 1 302a, feature 2 302b, feature 3 302b, and feature N 302N, where one or more of the features have been transformed. However, the disclosure is not intended to be limited to the examples described herein, such that the behavior cycle 301 may include any number of features.

The behavior cycle 301 may include information related to the features (e.g., 302a, 302b, 302c, 302N) over a time period 304. The time period 304 may include one or more cycles in which the information related to the features is collected. For example, the time period 304 may include a cycle 1 303a, a cycle 2 303b, up to a cycle N 303N. The number of cycles within the time period 304 or the number of features within each cycle may be preconfigured to dynamically configured.

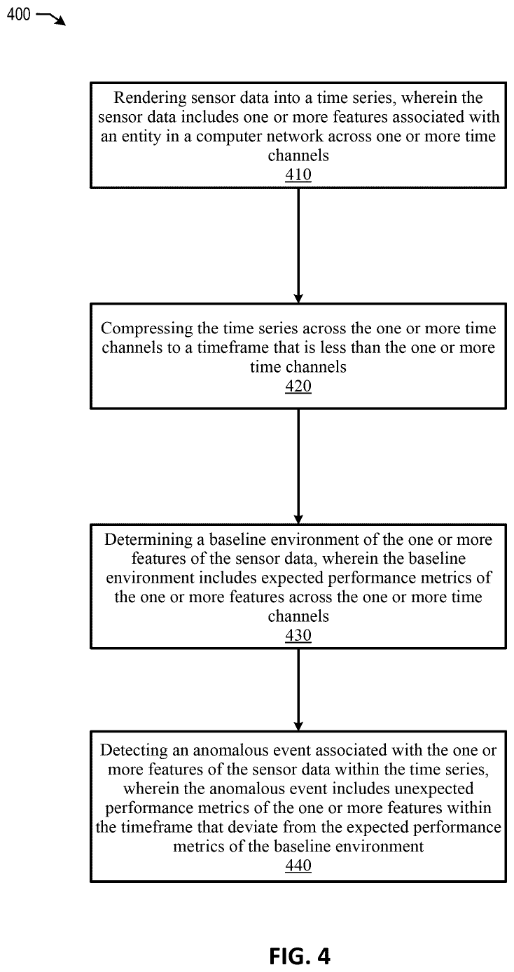

FIG. 4 is a flow diagram of a method 400 for detecting anomalous events within device-centric behavior cycles, in accordance with some embodiments.

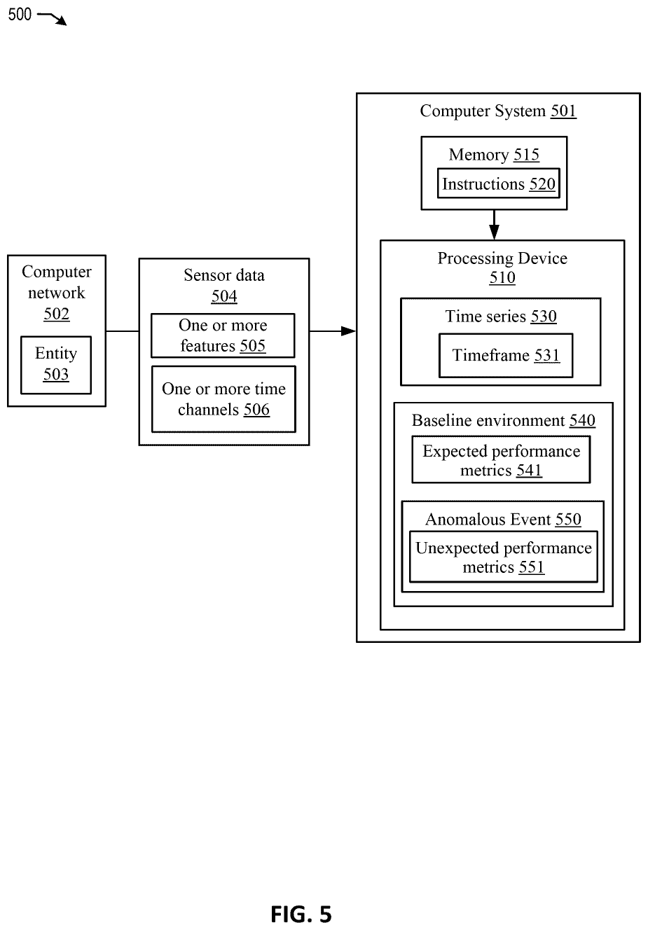

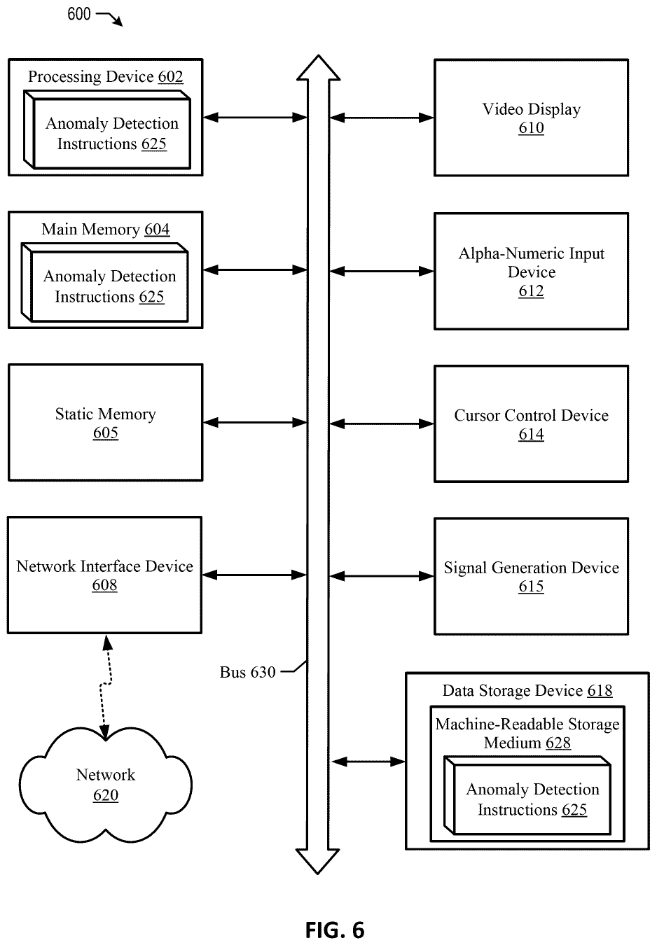

Method 400 may be performed by processing logic that may include hardware (e.g., a processing device), software (e.g., instructions running/executing on a processing device), firmware (e.g., microcode), or a combination thereof. In some embodiments, at least a portion of method 400 may be performed by behavior cycle processing 114 (shown in FIG. 1A), processing device 510 (shown in FIG. 5), processing device 602 (shown in FIG. 6), or a combination thereof.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, whereupon processing logic renders sensor data into a time series, where the sensor data includes one or more features associated with an entity in a computer network across one or more time windows. In one embodiment, the time series comprises a multivariate time series that tracks multiple variables associated with the one or more features.

At block 420, processing logic compresses the time series across the one or more time windows to a timeframe that is less that the one or more time windows. In one embodiment, the one or more time windows may comprise twenty-four hour period and the timeframe comprises a one hour period such that the information of the time series is compressed into the timeframe of the one hour period. In another embodiment, the one or more time windows may comprise a plurality of months and the timeframe comprises a day, week, or month such that the information of the time series is compressed into the timeframe of the day, week, or month period.

At block 430, processing logic determines a baseline environment of the one or more features of the sensor data, wherein the baseline environment includes expected performance metrics of the one or more features across the one or more time windows. In one embodiment, the expected performance metrics of the baseline environment include information of expected results of the one or more features within the one or more time windows. In some embodiments, the expected performance metrics of the one or more features may be the same or different for each of the one or more time windows. In some embodiments, the expected performance metrics of the one or more features may differ for different time windows at different time periods. For example, the expected performance metrics may differ based on seasonal changes, different time periods within a day, or the like. In some embodiments, device baselines may be created over time by behavior cycle tuples, which may be utilized to expose threat archetypes based on the baselines differentiating different classes of device (e.g., Internet of Things (IoT) devices) through their cyclic behaviors.

At block 440, processing logic detects an anomalous event associated with the one or more features of the sensor data within the time series. The anomalous event includes unexpected performance metrics of the one or more features within the timeframe that deviate from the expected performance metrics of the baseline environment. In some embodiments, the unexpected performance metrics of the one or more features may be the same or different for each of the one or more time windows. In some embodiments, the unexpected performance metrics of the one or more features may differ for different time windows at different time periods. For example, the unexpected performance metrics may differ based on seasonal changes, different time periods within a day, or the like.

In some embodiments, processing logic detects a rate of change of the anomalous event associated with the one or more features of the time series within at least the timeframe. In some embodiments, the rate of change of the anomalous event is detected within the one or more time windows. For example, a derivative or rate of change of behavior over time may assist in the detection of the anomalous event over different time periods that are greater than the timeframe.

In some embodiments, processing logic performs a time series transformation of one or more behavior cycles of the time series. In one embodiment, processing logic performs a static transformation of one or more behavior cycles of the time series.

In some embodiments, processing logic maps a behavior cycle of the time series to a malicious attack. In some embodiments, the behavior cycle of the time series comprises measurements of the one or more features within the one or more time windows. In one embodiment, processing logic maps the anomalous event to a threat archetype.

In some embodiments, processing logic transmits an indication of the anomalous event. For example, upon detection of an anomalous event, the processing logic transmits the indication of the detection of the anomalous event within the time series. The processing logic stores the indication of the detection of the anomalous event to be stored in memory. In some embodiments, the processing logic presents the indication of the detection of the anomalous event on a display device. For example, the indication of the detection of the anomalous event may be displayed as the multi-modal visualization of cycles (e.g., sonification). The multi-modal visualization of cycles (e.g., sonification) including the indication of the detection of the anomalous event may allow for a visual representation of one or more anomalous events within the time series.

FIG. 5 is a block diagram 500 that illustrates an example system for detecting anomalous events within device-centric behavior cycles, in accordance with some embodiments of the present disclosure.

Computer system 501 includes processing device 510 and memory 515. Memory 515 stores instructions 520 that are executed by processing device 510. The processing device is operatively coupled to the memory, to: render sensor data 504 into a time series 530, wherein the sensor data 504 includes one or more features 505 associated with an entity 503 in a computer network 502 across one or more time windows 506. The processing device is operatively coupled to the memory, to: compresses the time series 530 across the one or more time windows 506 to a timeframe 531 that is less than the one or more time windows.

The processing device is operatively coupled to the memory, to: determine a baseline environment 540 of the one or more features of the sensor data, wherein the baseline environment includes expected performance metrics 541 of the one or more features across the one or more time windows. The processing device is operatively coupled to the memory, to: detect an anomalous event 550 associated with the one or more features of the sensor data within the time series, wherein the anomalous event includes unexpected performance metrics 551 of the one or more features within the time frame that deviate from the expected performance metrics of the baseline environment. In some embodiments, the processing device is operatively coupled to the memory, to: detect a rate of change of the anomalous event associated with the one or more features of the time series within at least the timeframe. In some embodiments, the processing device is operatively coupled to the memory, to: perform a time series transformation of one or more behavior cycles of the time series. In some embodiments, the processing device is operatively coupled to the memory, to: perform a static transformation of one or more behavior cycles of the time series. In some embodiments, the processing device is operatively coupled to the memory, to: map a behavior cycle of the time series to a malicious attack.

FIG. 6 illustrates a diagrammatic representation of a machine in the example form of a computer system 600 within which a set of instructions, for causing the machine to perform any one or more of the methodologies discussed herein for lateral movement detection training.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 600 may be representative of a server.

The exemplary computer system 600 includes a processing device 602, a main memory 604 (e.g., read-only memory (ROM), flash memory, dynamic random access memory (DRAM), a static memory 605 (e.g., flash memory, static random access memory (SRAM), etc.), and a data storage device 618 which communicate with each other via a bus 630. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 600 may further include a network interface device 608 which may communicate with a network 620. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse) and an acoustic signal generation device 615 (e.g., a speaker). In some embodiments, video display unit 610, alphanumeric input device 612, and cursor control device 614 may be combined into a single component or device (e.g., an LCD touch screen).

Processing device 602 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute anomaly detection instructions 625, for performing the operations and steps discussed herein.

The data storage device 618 may include a machine-readable storage medium 628, on which is stored one or more sets of anomaly detection instructions 625 (e.g., software) embodying any one or more of the methodologies of functions described herein. The anomaly detection instructions 625 may also reside, completely or at least partially, within the main memory 604 or within the processing device 602 during execution thereof by the computer system 600; the main memory 604 and the processing device 602 also constituting machine-readable storage media. The anomaly detection instructions 625 may further be transmitted or received over a network 620 via the network interface device 608.

The machine-readable storage medium 628 may also be used to store instructions to perform a method for intelligently scheduling containers, as described herein. While the machine-readable storage medium 628 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “rendering,” “compressing,” “determining,” “detecting,” “performing,” “mapping,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method comprising:
rendering sensor data into a time series, wherein the sensor data includes one or more features associated with an entity in a computer network across one or more time windows;
compressing the time series across the one or more time windows to a timeframe that is less than the one or more time windows;
determining a baseline environment of the one or more features of the sensor data, wherein the baseline environment includes expected performance metrics of the one or more features across the one or more time windows; and
detecting, by a processing device, an anomalous event associated with the one or more features of the sensor data within the time series, wherein the anomalous event includes unexpected performance metrics of the one or more features within the timeframe that deviate from the expected performance metrics of the baseline environment.

2. The method of claim 1, further comprising:
detecting a rate of change of the anomalous event associated with the one or more features of the time series within at least the timeframe.

3. The method of claim 2, wherein the rate of change of the anomalous event is detected within the one or more time windows.

4. The method of claim 1, wherein the time series comprises a multivariate time series that tracks multiple variables associated with the one or more features.

5. The method of claim 1, wherein the compressing the time series further comprises:
performing a time series transformation of one or more behavior cycles of the time series.

6. The method of claim 1, wherein the compressing the time series further comprises:
performing a static transformation of one or more behavior cycles of the time series.

7. The method of claim 1, wherein the detecting the anomalous event further comprises:
mapping a behavior cycle of the time series to a malicious attack, wherein the behavior cycle of the time series comprises measurements of the one or more features within the one or more time windows.

8. The method of claim 1, further comprising:
mapping the anomalous event to a threat archetype.

9. The method of claim 1, further comprising:
performing a vector transformation of one or more behavior cycles of the time series; and
inputting the vector transformation of one or more behavior cycles of the time series in a large language model.

10. A system comprising:
a memory; and
a processing device, operatively coupled to the memory, to:
render sensor data into a time series, wherein the sensor data includes one or more features associated with an entity in a computer network across one or more time windows;
compress the time series across the one or more time windows to a timeframe that is less than the one or more time windows;
determine a baseline environment of the one or more features of the sensor data, wherein the baseline environment includes expected performance metrics of the one or more features across the one or more time windows; and
detect an anomalous event associated with the one or more features of the sensor data within the time series, wherein the anomalous event includes unexpected performance metrics of the one or more features within the timeframe that deviate from the expected performance metrics of the baseline environment.

11. The system of claim 10, wherein the processing device is further to:
detect a rate of change of the anomalous event associated with the one or more features of the time series within at least the timeframe.

12. The system of claim 11, wherein the rate of change of the anomalous event is detected within the one or more time windows.

13. The system of claim 10, wherein the processing device is further to:
perform a time series transformation of one or more behavior cycles of the time series.

14. The system of claim 10, wherein the processing device is further to:
perform a static transformation of one or more behavior cycles of the time series.

15. The system of claim 10, wherein the processing device is further to:
map a behavior cycle of the time series to a malicious attack.

16. The system of claim 15, wherein the behavior cycle of the time series comprises measurements of the one or more features within the one or more time windows.

17. A non-transitory computer readable medium, storing instructions that, when executed by a processing device, cause the processing device to:
render sensor data into a time series, wherein the sensor data includes one or more features associated with an entity in a computer network across one or more time windows;
compress the time series across the one or more time windows to a timeframe that is less than the one or more time windows;
determine a baseline environment of the one or more features of the sensor data, wherein the baseline environment includes expected performance metrics of the one or more features across the one or more time windows; and
detect, by the processing device, an anomalous event associated with the one or more features of the sensor data within the time series, wherein the anomalous event includes unexpected performance metrics of the one or more features within the timeframe that deviate from the expected performance metrics of the baseline environment.

18. The non-transitory computer readable medium of claim 17, wherein the instructions, when executed by the processing device, cause the processing device further to:
detect a rate of change of the anomalous event associated with the one or more features of the time series within at least the timeframe, wherein the rate of change of the anomalous event is detected within the one or more time windows.

19. The non-transitory computer readable medium of claim 17, wherein the processing device is further to:
perform a time series transformation of one or more behavior cycles of the time series.

20. The non-transitory computer readable medium of claim 17, wherein the processing device is further to:
perform a static transformation of one or more behavior cycles of the time series.
